(19) United States
(12) Patent Application Publication
(10) Pub. No.: US 2014/0145075 A1
(43) Pub. Date: May 29, 2014

(54) ATMOSPHERIC PRESSURE INTERFACE ION SOURCE AND MASS SPECTROMETER

(71) Applicants: Xiaohua Zhang, Beijing (CN); Houle Wang, Beijing (CN); Hua Zhang, Beijing (CN); Yingjian Shang, Beijing (CN); Yongguang Du, Beijing (CN)

(72) Inventors: Xiaohua Zhang, Beijing (CN); Houle Wang, Beijing (CN); Hua Zhang, Beijing (CN); Yingjian Shang, Beijing (CN); Yongguang Du, Beijing (CN)

(73) Assignee: BEIJING PURKINJE GENERAL INSTRUMENT CO., LTD., Beijing (CN)

(21) Appl. No.: 14/235,905

(22) PCT Filed: Jul. 29, 2011
(86) PCT No.: PCT/CN2011/077796

§ 371 Date: Jan. 29, 2014

(51) Int. Cl. H01J 49/16

(52) U.S. Cl. CPC H01J 49/168
USPC 250/288

(57) ABSTRACT

An API (Atmospheric Pressure Interface) ion source and a mass spectrometer with the same are disclosed. In the disclosed API ion source and the mass spectrometer with the same, the included angle α between the capillary (2) and the mass analyzer (4) of the mass spectrometer (10) is 80°˜150°. The repeller electrode (3) is installed outside the included angle a and a 110˜380V DC voltage is applied thereto, so that the sample ions with low kinetic energy in the sample ion flow passed through the capillary (2) change the flying direction thereof by an angle with 180°-α and subsequently enter the mass analyzer (4).

### TECHNICAL FIELD

The present disclosure relates to an API (Atmospheric Pressure Interface) ion source and a mass spectrometer used in the field of analytical instruments.

### BACKGROUND

A liquid chromatography-mass spectrometry system mainly including a liquid chromatography and a mass spectrometry is widely used in the field of scientific and biological detection and analysis. The liquid chromatograph is used to initially treat a liquid sample to be detected, so as to form a relatively pure liquid sample. The mass spectrometry mainly includes an API (Atmospheric Pressure Interface) ion source and a mass analyzer, etc. The API ion source includes a charged spray needle, a capillary and a heating device for heating the capillary. The charged spray needle is disposed in the atmosphere to receive the relatively pure liquid sample treated by the liquid chromatograph and to ionize the liquid sample so as to form gaseous charged ions. One end of capillary is introduced into the mass spectrometer and the other end thereof is disposed in the atmosphere. The pressure difference between the inside of the mass spectrometer and the atmosphere makes the ionized sample ions form a sample ion flow, then the sample ion flow is sucked into the mass spectrometer through the capillary. In a conventional API ion source, the capillary and the mass analyzer of the mass spectrometry are installed around the same central line, so that the ion flow flies into the mass analyzer in a straight line.

As shown in FIG. 1, there is a high potential difference between a capillary 2 and a spay needle 1, which may be maintained by utilizing a high voltage power supply or by other means. A Taylor cone is formed at the spray opening of the spray needle 1 under the effect of an electric field, which causes that the liquid sample is converted into a large quantity of charged liquid droplets. Coulomb explosion is occurred in the charged liquid and a part of the solvent is evaporated off, so that the charged liquid droplets are converted into smaller charged spray droplets. A sample ion flow is formed from the small charged spray droplets and enters the capillary 2 under the directing and carrying effects of an air flow, and the solvent in the small charged spray droplets is further evaporated off under the high temperature in the capillary 2. Therefore, the small charged spray droplets become smaller as they pass through the capillary 2, and finally enter the mass analyzer.

Generally, at the same time when the liquid sample spray droplets are converted into the ion flow through the capillary, there are unionized liquid sample such as neutral particles, e.g., impurity particles, solvent particles, solvent molecular group, there still are charged spray droplets with large mass-to-charge ratios from which the solvent is not removed completely. In the conventional API ion source, the ions, the charged spray droplets and the impurity particles, the solvent particles, and the solvent molecular group will enter the mass analyzer altogether since a direction of an original motion is directly aligned to an entrance of the mass analyzer, and thus the components in the mass analyzer such as electrodes, and the like are contaminated, static electricity is built up locally, and an ideal electric field distribution inside the mass analyzer is disturbed. Therefore, analysis accuracy and sensitivity of the mass spectrometer is seriously affected. Meanwhile, noise signals will be generated since the spray droplets directly enter the mass analyzer, so that the signal-to-noise ratio of the mass spectrometer is reduced. In order to reduce the neutral particles such as impurity particles, solvent particles, solvent molecular group, which enter the mass analyzer, the conventional API ion source is further provided with a blowing device to blow high temperature nitrogen in a direction opposite to the direction of the sample ion flow in the capillary, so as to further evaporate the solvent in the neutral particles, so that the neutral particles are converted into low mass particles, thereby reducing the contamination of the mass analyzer. However, it wastes a large quantity of resources such as nitrogen and electricity power, etc.

### SUMMARY

An object of the present disclosure is to provide an API ion source and a mass spectrometer without affecting the analysis accuracy and sensitivity, to solve the above technical problem in the prior art that the analysis accuracy and sensitivity is low due to the drawbacks of the API ion source.

In order to achieve the above object, the present disclosure provides the following solutions.

One aspect of the disclosure provides an atmospheric pressure interface (API) ion source, including: a capillary, one end thereof is introduced into a mass spectrometer and the other end thereof is disposed in atmosphere, wherein a pressure difference between inside of the mass spectrometer and the atmosphere makes ionized sample ions form a sample ion flow, and the sample ion flow is sucked through the capillary into the mass spectrometer, and wherein an included angle α between a center line of the capillary and a center line of a mass analyzer of the mass spectrometer is 80°˜150°; a repeller electrode configured to be installed outside the included angle α and to have a 110˜380V DC voltage applied thereto, wherein an electricity field is generated by the DC voltage to make sample ions with low kinetic energy in the sample ion flow passed through the capillary change a flying direction thereof by an angle with 180°-α and subsequently enter the mass analyzer.

Alternatively, the included angle α is 90°.

Alternatively, a surface of the repeller electrode facing the included angle α is of a semi-cylinder shape, a spherical shape, an ellipsoid shape, a cone shape, a frustum shape or a plane shape.

Alternatively, the repeller electrode is provided with a hole or a slit to allow high kinetic energy sample particles and neutral particles to pass through.

Alternatively, the API ion source further includes an ion guide device configured to be installed between the repeller electrode and the mass analyzer.

Alternatively, the ion guide device is an electrode rod guide device including four, six or eight electrode rods which is arranged in parallel and uniformly distributed in a circumferential direction, wherein a radiofrequency current with a voltage of 100˜400V and a frequency of 600 kHz˜2 MHz is applied to each of the electrode rods. The ion guide device is an ion funnel including a plurality of electrode plates arranged in parallel and insulated to each other; each of the electrode plates is provided with a through hole at a center thereof for allowing the sample ions to pass through, and the through holes of the plurality of electrode plates are decreased gradually along the flying direction of the sample ions; a vacuum degree of an area where the ion funnel is located is 65 pa˜650 pa; a DC voltage applied to the electrode plate close to the repeller electrode is 60˜100V; a DC voltage applied to the electrode plate close to the mass analyzer is 25˜65V; the DC voltages applied to the plurality of electrode plates is decreased gradually in a arithmetic sequence along the flying direction of the sample ions; each of the electrode plates is configured to be applied with an AC voltage; and phase differences of two adjacent electrode plates are identical.

Alternatively, the vacuum degree of the area where the ion funnel is located is 110 pa˜150 pa.

Alternatively, the DC voltages applied to the plurality of electrode plates are decreased gradually in the arithmetic sequence along the flying direction of the sample ions.

Another aspect of the disclosure provides a mass spectrometer including a mass analyzer and an atmospheric pressure interface (API) ion source, wherein the API ion source is the API ion source according to the disclosure.

It can be seen from the above solutions that the API ion source and the mass spectrometer according to the present disclosure have the following advantages and positive effects. Since the API ion source is provided with the repeller electrode, and the electric field generated by the repeller electrode may separate the sample ions with low kinetic energy from impurity, molecular group and spray droplets particles, etc., which have high kinetic energy. The sample ions change their flying direction under the effects of the electric field of the repeller electrode and are capable of entering the mass analyzer subsequently. The impurity droplets or particles have high kinetic energy and large inertia, and thus the angles changed by them in their flying direction under the effects of the electric field of the repeller electrode are smaller than that of the sample ions, so that they are prevented from entering the mass analyzer due to their strong inertia. Therefore, in the API ion source and the mass spectrometer according to the present disclosure, only the stable sample ions are capable of entering the mass analyzer, and other spray droplets, molecular group and particles, etc., are prevented from entering the mass analyzer. Therefore, it effectively avoids that the spray droplets, molecular group and particles, and the like contaminate the components in the mass analyzer such as electrodes, etc., and thus the analysis accuracy, sensitivity and signal-to-noise ratio are improved. Meanwhile, in the present disclosure, since neutral particles such as impurity particles, solvent particles, solvent molecular group, and the like are screened out by the repeller electrode before the mass analyzer, there is no need for a blowing device. Therefore, a large quantity of resources such as nitrogen and electricity power, etc., may be saved.

The above and other objects, features and advantages will become apparent from the following description of the embodiments with reference to the accompany drawings.

### BRIEF DESCRIPTION OF THE DRAWINGS

FIG. 1 is a schematic structure view showing the conventional API ion source and the change in the liquid sample during its flying after being ionized.

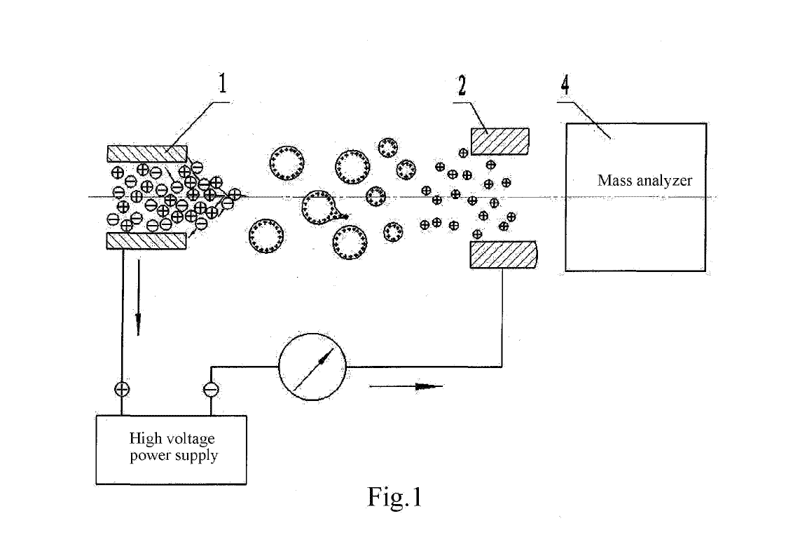

FIG. 2 is a schematic structure view showing an API ion source according to a first embodiment of the disclosure.

FIG. 3 is a schematic mechanical structure view showing the API ion source according to the disclosure.

FIG. 4 is a simulation view showing that the sample ion is flying in the API ion source according to the disclosure.

FIG. 5 is a schematic structure view showing an API ion source according to a second embodiment of the disclosure.

### DETAILED DESCRIPTION

Hereinafter, specific embodiments of the disclosure are described with reference to the accompanying drawings. It should be noted that the embodiments described herein are used merely to illustrate the disclosure, rather than to limit it.

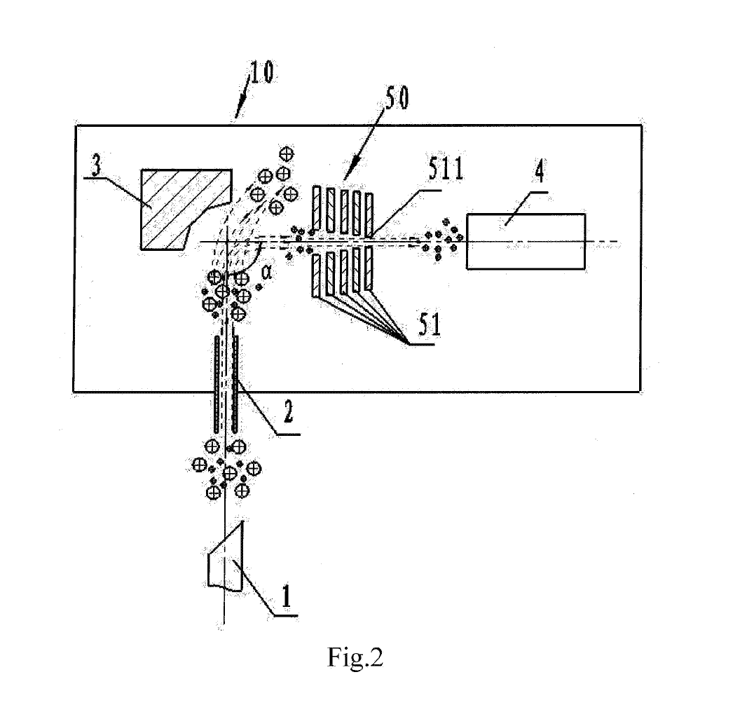

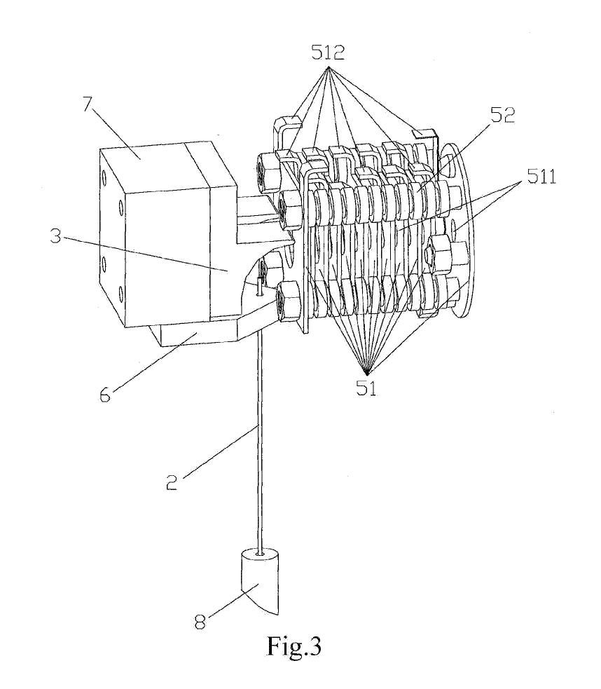

As illustrated in FIG. 2 and FIG. 3, an API (Atmospheric Pressure Interface) ion source according to a first embodiment of the disclosure mainly includes a charged spray needle 1, a capillary 2, a heating device (not shown) for heating the capillary and a repeller electrode 3.

The charged spray needle 1 may be the same as that of the API ion source with a conventional structure.

The capillary 2 may be the same as that of the API ion source with the conventional structure, and may be charged or uncharged. One end of the capillary 2 is disposed in the atmosphere and supported by a porcelain bushing 8, and the other end thereof is introduced into the mass spectrometer 10 and supported by a capillary shelf 6. Due to the pressure difference between the inside of the mass spectrometer and the atmosphere, a sample ion flow is formed from the sample ions and is sucked into the mass spectrometer 10 through the capillary 2. An included angle α between a central line of the capillary 2 and a central line of a mass analyzer 4 of the mass spectrometer 10 is 90°. The included angle α is not limited to 90°. The included angle may be determined depending on factors such as the overall structure of the mass spectrometer, and the strength of the electric field of the repeller electrode 3. Generally, the included angle is within the range of 80°˜150°. The sample ion flow enters the mass spectrometer through the capillary 2 and the solvent in the sample ion flow is further evaporated under the high temperature in the capillary 2. The sample ion flow flying from the capillary 2 includes ions or clusters of ions, and unionized liquid sample molecules such as impurity particles, solvent particles, solvent molecular group, etc., as well as some charged spray droplets with large mass-to-charge ratios from which the solvent is not removed completely.

The repeller electrode 3 is installed outside the included angle α. The electric field generated under the DC voltage of the repeller electrode 3 may spread the sample ions, the impurity particles, the solvent particles, the solvent molecular group, and the like which have passed through the capillary 2. The electric field intensity of the repeller electrode 3 enables the sample ions with low kinetic energy in the sample ion flow to change the flying direction thereof by 90° and enter the mass analyzer 4 subsequently. If the included angle α between the central line of the capillary 2 and the central line of the mass analyzer 4 of the mass spectrometer is 120°, the repeller electrode 3 may change the flying direction of the sample ions in the sample ion flow by 60°, so that they may enter the mass analyzer 4 subsequently. That is, an angle value of the flying direction of the sample ion flow changed by the repeller electrode 3 equals to 180°-α, so as to ensure the sample ions with low kinetic energy in the sample ion flow to enter the mass analyzer 4. As is known, there is a certain vacuum degree in the mass spectrometer; the pressure difference between inside and outside of the mass spectrometer make the air form an air flow; and under the carrying effect of the air flow, the sample spray droplet particles ionized by the charged spray needle enter the inside of the mass spectrometer through the capillary. The velocities of various the sample spray droplet particles at the entrance of the capillary are different; while they are all close to the velocity of the air flow inside the capillary upon the sample spray droplet particles depart from the capillary. That is to say, upon the sample spray droplets particles depart from the capillary, the velocities of various sample spray droplets particles are substantially the same. According to the kinetic energy equation Eₖ=½ mv² (wherein m is the mass and v is the velocity), the kinetic energy of the sample spray droplets particles is proportional to their mass. Because the mass of the incompletely ionized neutral particles such as impurity particles, solvent particles, solvent molecular group, and the like is generally far greater than that of the sample ions, the kinetic energy thereof is also far greater than that of the sample ions. As a result, the incompletely ionized impurity particles, solvent particles, solvent molecular group, and the like have large kinetic energy and large inertia due to their large mass, so that they cannot be easily deflected by the electric field; therefore, they are deflected by an angle which is far less than that of the sample ions, even if they may be deflected from the original flying direction. Consequently, these ions with large mass to charge ratios, impurity particles, solvent particles and solvent molecular group, and the like cannot fly into the mass analyzer 4, but fly out through the edges of the repeller electrode 3 or through the holes or slits of the repeller electrode. A surface of the repeller electrode 3 facing the included angle α is of a semi-cylinder shape. It also may be of a spherical shape, an ellipsoid shape, a cone shape, a frustum shape or a plane shape and other shapes. The repeller electrode 3 may be provided with holes or slits to allow the neutral particles and high kinetic energy particles to pass through. Thus, these neutral particles or high kinetic energy particles will not reach any electrode, so that the electrode will not be contaminated. Depending on the variety of the liquid sample, the DC voltage of the repeller electrode 3 is generally within the range of 110˜380V.

In the solution of the first embodiment of the disclosure, the API ion source further includes an ion guide device which is an ion funnel 50 installed between the mass analyzer 4 and the repeller electrode 3. The ion funnel 50 includes a plurality of electrode plates 51 arranged in parallel. Each of the electrode plates 51 is provided with a through hole 511 at the center thereof for allowing the sample ions to pass through. The through holes 511 of the plurality of electrode plates 51 are decreased gradually along the flying direction of the sample ions. An insulator plate 52 is provided between two adjacent electrode plates 51. An electric connection portion 512 is provided on each of the electrode plates 51 to be connected to an electric circuit board. The vacuum degree of the area where the ion funnel 50 is located is 60 pa˜650 pa; the DC voltage applied to the electrode plate 51 close to the repeller electrode 3 is 60˜100V; and the DC voltage applied to the electrode plate 51 close to the mass analyzer 4 is 25˜65V. The DC voltages applied to the plurality of electrode plates 51 are gradually decreased in an arithmetic sequence along the flying direction of the sample ions. An AC voltage is applied to each of the electrode plates 51, and preferably the phase differences of two adjacent electrode plates are identical, for example the phase difference of each two adjacent electrode plates is a half-period. With the ion funnel 50 working under the conditions of above vacuum degree, DC voltage and AC voltage, the sample ions may be focused better, therefore the sample ions may be effectively focused and centralized even if the initial energy and the deflected angles thereof are not completely identical. The collision between the ion flow and the background air may further reduce the temperature of the sample ions, which is beneficial to allow the sample ions to fly out of the ion funnel at a suitable velocity. In particular, when the vacuum degree of the area where the ion funnel 50 is located is 110 pa˜150 pa, particularly about 130 pa, and the DC voltages applied to the plurality of electrode plates 51 are gradually decreased in the arithmetic sequence along the flying direction of the sample ions, the sample ions may fly out of the ion funnel 50 more smoothly and fly into the mass analyzer 4. The decreasing rule that DC voltages applied to the plurality of electrode plates 51 are decreased along the flying direction of the sample ions is not limited to the arithmetic sequence, other decreasing rules may be used. The DC voltage applied to the electrode plate 51 close to the repeller electrode 3 is not limited to 60˜100V, and the DC voltage applied to the electrode plate 51 close to the mass analyzer 4 is not limited to 25˜65V.

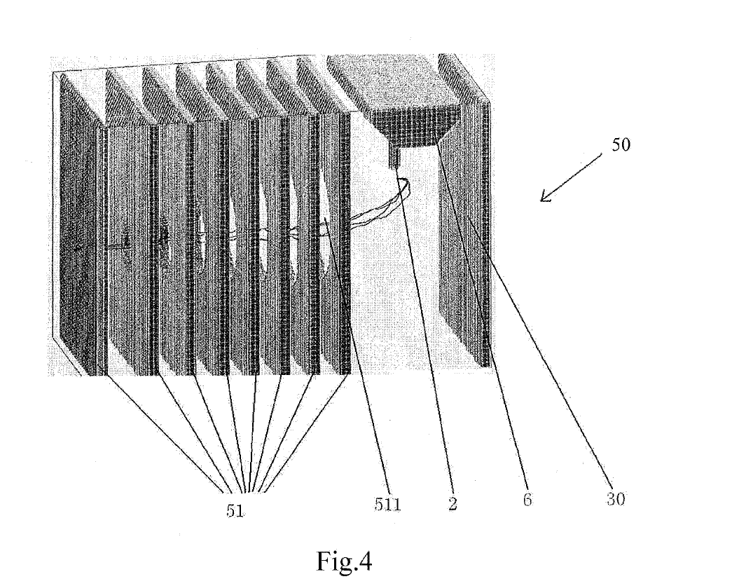

As illustrated in FIG. 4, the sample is reserpine and a molecular weight thereof is 609; a planar repeller electrode 30 is selected as the repeller electrode; the vacuum degree of the area where the funnel 50 is located is 130 pa; a DC voltage applied to a first electrode plate 51 (the electrode plate close to the repeller electrode 3) along the flying direction of the sample ions is 100V; a DC voltage applied to a second electrode plate 51 is 93V; a DC voltage applied to a third electrode plate 51 is 86V; a DC voltage applied to a fourth electrode plate 51 is 79V; a DC voltage applied to a fifth electrode plate 51 is 72V; a DC voltage applied to a sixth electrode plate 51 is 65V; a DC voltage applied to a seventh electrode plate 51 is 58V; and a DC voltage applied to a second electrode plate 51 is 51V. It can be seen from FIG. 4, the sample ions flying out of the capillary 2 pass through the funnel 50 smoothly and finally fly into the mass analyzer.

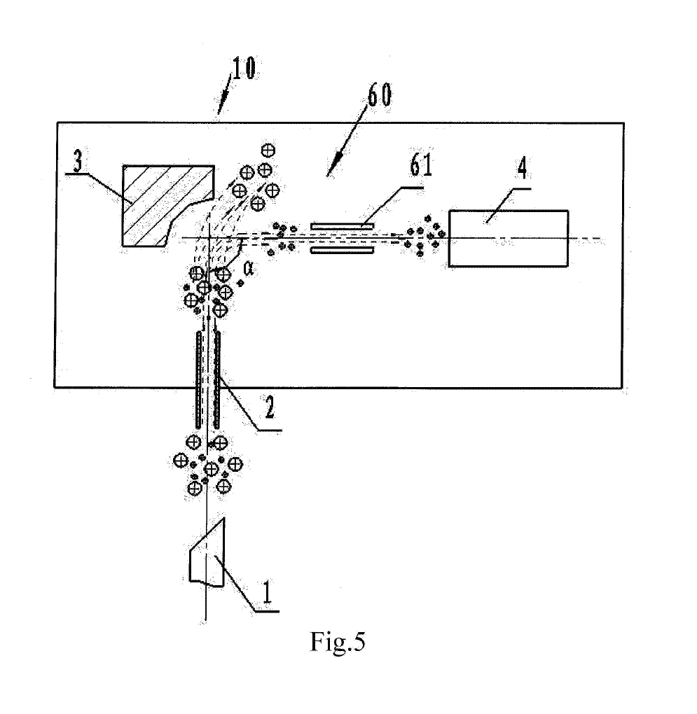

As illustrated in FIG. 5, an API ion source according to a second embodiment of the disclosure differs from that of the first embodiment only in that an ion guide device is an electrode rod guide device 60 installed between the mass analyzer 4 and the repeller electrode 3. The electrode rod guide device 60 includes four, six, eight or other number of electrode rods 61 which are arranged parallel to each other and uniformly distributed in a circumferential direction. A cross sectional shape of the electrode rods 61 may be circular, rectangular or other shapes. A radiofrequency current with a voltage of 100˜400V and a frequency of 600 kHz˜2 MHz is applied to each of the electrode rods 61. Likewise, the electrode rod guide device according to the second embodiment may achieve an excellent cooling and focusing effect on the sample ion beam.

The mass spectrometer 10 according to the disclosure includes the mass analyzer 4 and the API ion source as described above of which the description will not be repeated.

### INDUSTRIAL APPLICABILITY

In summary, the API ion source according to the disclosure is provided with the repeller electrode, and the electric field generated by the repeller electrode may separate the sample ions with low kinetic energy from the impurity, molecular group and spray droplets particles, and the like which have high kinetic energy. The sample ions change their flying direction under the effects of the electric field of the repeller electrode and are capable of entering the mass analyzer after the change of the flying direction. Moreover, each of the spray droplets, molecular group and particles, and the like is prevented from entering the mass analyzer. Therefore, it effectively avoids that the spray droplets, molecular group and particles, and the like contaminate the components in the mass analyzer such as electrodes, etc., and thus the analysis accuracy, sensitivity and signal-to-noise ratio are improved. Meanwhile, since neutral particles such as impurity particles, solvent particles, solvent molecular group, and the like are screened out by the repeller electrode before the mass analyzer, there is no need for a blowing device. Therefore, a large quantity of resources such as nitrogen and electricity power, and the like may be saved.

The above detailed description of the embodiments is intended to make the features and spirits of the application more clear, rather than to limit the scope of the application. Conversely, it is intended to cover various modifications and equivalent arrangements within the protection scope of the application. Therefore, the protection scope of the application should be interpreted as broad as possible based on the above description, so that all possible modifications and equivalent arrangements may be covered therein.

1. An atmospheric pressure interface (API) ion source, comprising:
a capillary (2), one end thereof is introduced into a mass spectrometer and the other end thereof is disposed in atmosphere, wherein a pressure difference between inside of the mass spectrometer and the atmosphere makes ionized sample ions form a sample ion flow, and the sample ion flow is sucked through the capillary (2) into the mass spectrometer, and wherein an included angle α between a center line of the capillary (2) and a center line of a mass analyzer (4) of the mass spectrometer is 80°˜150°;
a repeller electrode (3) configured to be installed outside the included angle α and to have a 110˜380V DC voltage applied thereto, wherein an electricity field is generated by the DC voltage to make sample ions with low kinetic energy in the sample ion flow passed through the capillary (2) change a flying direction thereof by an angle with 180°-α and subsequently enter the mass analyzer (4).

2. The API ion source according to claim 1, wherein the included angle α is 90°.

3. The API ion source according to claim 1, wherein a surface of the repeller electrode (3) facing the included angle α is of a semi-cylinder shape, a spherical shape, an ellipsoid shape, a cone shape, a frustum shape or a plane shape.

4. The API ion source according to claim 1, wherein the repeller electrode (3) is provided with a hole or a slit to allow high kinetic energy sample particles and neutral particles to pass through.

5. The API ion source according to claim 1, further comprising:
an ion guide device configured to be installed between the repeller electrode (3) and the mass analyzer (4).

6. The API ion source according to claim 5, wherein the ion guide device is an electrode rod guide device (60) comprising four, six or eight electrode rods (61) which is arranged in parallel and uniformly distributed in a circumferential direction, wherein a radiofrequency current with a voltage of 100˜400V and a frequency of 600 kHz˜2 MHz is applied to each of the electrode rods (61).

7. The API ion source according to claim 5, wherein the ion guide device is an ion funnel (50) comprising a plurality of electrode plates (51) arranged in parallel and insulated to each other;
and wherein each of the electrode plates (51) is provided with a through hole (511) at a center thereof for allowing the sample ions to pass through, and the through holes (511) of the plurality of electrode plates (51) are decreased gradually along the flying direction of the sample ions;
a vacuum degree of an area where the ion funnel (50) is located is 65 pa˜650 pa;
a DC voltage applied to the electrode plate (51) close to the repeller electrode (3) is 60˜100V;
a DC voltage applied to the electrode plate (51) close to the mass analyzer (4) is 25˜65V;
the DC voltages applied to the electrode plates (51) is decreased gradually along the flying direction of the sample ions;
each of the plurality of electrode plates (51) is configured to be applied with an AC voltage is applied to; and
phase differences of two adjacent electrode plates (51) of the plurality of electrode plates (51) are identical.

8. The API ion source according to claim 7, wherein the vacuum degree of the area where the ion funnel (50) is located is 110 pa˜150 pa.

9. The API ion source according to claim 7, wherein the DC voltages applied to the plurality of electrode plates (51) are decreased gradually in the arithmetic sequence along the flying direction of the sample ions.

10. A mass spectrometer, comprising a mass analyzer (4) and an atmospheric pressure interface (API) ion source, wherein the API ion source comprises:
a capillary (2), one end thereof is introduced into a mass spectrometer and the other end thereof is disposed in atmosphere, wherein a pressure difference between inside of the mass spectrometer and the atmosphere makes ionized sample ions form a sample ion flow, and the sample ion flow is sucked through the capillary (2) into the mass spectrometer, and wherein an included angle α between a center line of the capillary (2) and a center line of a mass analyzer (4) of the mass spectrometer is 80°˜150°;
a repeller electrode (3) configured to be installed outside the included angle α and to have a 110˜380V DC voltage applied thereto, wherein an electricity field is generated by the DC voltage to make sample ions with low kinetic energy in the sample ion flow passed through the capillary (2) change a flying direction thereof by an angle with 180°-α and subsequently enter the mass analyzer (4).

11. The mass spectrometer according to claim 10, wherein the included angle α is 90°.

12. The mass spectrometer according to claim 10, wherein a surface of the repeller electrode (3) facing the included angle α is of a semi-cylinder shape, a spherical shape, an ellipsoid shape, a cone shape, a frustum shape or a plane shape.

13. The mass spectrometer according to claim 10, wherein the repeller electrode (3) is provided with a hole or a slit to allow high kinetic energy sample particles and neutral particles to pass through.

14. The mass spectrometer according to claim 10, wherein the API ion source further comprises:
an ion guide device configured to be installed between the repeller electrode (3) and the mass analyzer (4).

15. The mass spectrometer according to claim 11, wherein the API ion source further comprises:
an ion guide device configured to be installed between the repeller electrode (3) and the mass analyzer (4).

16. The mass spectrometer according to claim 14, wherein the ion guide device is an electrode rod guide device (60) comprising four, six or eight electrode rods (61) which is arranged in parallel and uniformly distributed in a circumferential direction, wherein a radiofrequency current with a voltage of 100˜400V and a frequency of 600 kHz˜2 MHz is applied to each of the electrode rods (61).

17. The mass spectrometer according to claim 14, wherein the ion guide device is an ion funnel (50) comprising a plurality of electrode plates (51) arranged in parallel and insulated to each other;
and wherein each of the electrode plates (51) is provided with a through hole (511) at a center thereof for allowing the sample ions to pass through, and the through holes (511) of the plurality of electrode plates (51) are decreased gradually along the flying direction of the sample ions;
a vacuum degree of an area where the ion funnel (50) is located is 65 pa˜650 pa;
a DC voltage applied to the electrode plate (51) close to the repeller electrode (3) is 60˜100V;
a DC voltage applied to the electrode plate (51) close to the mass analyzer (4) is 25˜65V;
the DC voltages applied to the electrode plates (51) is decreased gradually along the flying direction of the sample ions;
each of the plurality of electrode plates (51) is configured to be applied with an AC voltage is applied to; and
phase differences of two adjacent electrode plates (51) of the plurality of electrode plates (51) are identical.

18. The mass spectrometer according to claim 17, wherein the vacuum degree of the area where the ion funnel (50) is located is 110 pa˜150 pa.

19. The mass spectrometer according to claim 17, wherein the DC voltages applied to the plurality of electrode plates (51) are decreased gradually in the arithmetic sequence along the flying direction of the sample ions.

20. The API ion source according to claim 2, further comprising:
an ion guide device configured to be installed between the repeller electrode (3) and the mass analyzer (4).
